(19) United States
(12) Patent Application Publication
(10) Pub. No.: US 2018/0218074 A1
(43) Pub. Date: Aug. 2, 2018

(54) PRECISION SEARCH AND EXTRACTION OF MEDICAL IMAGES AND DATA IN CLOUD-BASED STORAGE

(71) Applicant: Konica Minolta Healthcare Americas, Inc., Wayne, NJ (US)

(72) Inventors: Takayuki Ishikawa, Wayne, NJ (US); Takao Shiibashi, Wayne, NJ (US); Yutaka Ueda, Wayne, NJ (US)

(73) Assignee: Konica Minolta Healthcare Americas, Inc., Wayne, NJ (US)

(21) Appl. No.: 15/419,276

(22) Filed: Jan. 30, 2017

(51) Int. Cl. G06F 17/30; G06F 19/00

(52) U.S. Cl. CPC G06F 17/30864; G06F 17/30274; G06F 19/321

(57) ABSTRACT

A method to search, extract, and display medical images and data between a plurality of medical repositories on a plurality of medical servers of healthcare facilities within a network. The plurality of medical servers are connected through a data integration controller and includes a local medical server and two or more remote medical servers. The method causes the local medical server to: transmit a search request to the plurality of remote medical servers; receive and display medical information associated with the search request from the plurality of remote medical servers; transmit, a medical data retrieval request to retrieve medical data associated with medical information selected by a user; receive the medical data associated with the medical data retrieval request; and display the received medical data to the user.

### BACKGROUND

Medical images and medical data play a crucial role in the diagnosis of a patient. Healthcare facilities (e.g., hospitals) have realized the benefits of electronically storing medical images and medical data. The digitalization of the medical images and data (“medical data”) not only enables healthcare professionals to easily access medical images and medical data, but also enables the images and data to be easily shared between multiple healthcare facilities through the use of physical mediums such as compact discs (CDs), digital video discs (DVDs), and Universal Serial Bus (USB) flash drives.

More recently, cloud-based storage systems have emerged as a way to improve efficiency and accessibility of information. In general, a “cloud” can be understood as an online storage system that provides remote, on-demand access of computing resources and data over the Internet to multiple computers and devices in various locations. Cloud-based storage may be provided by vendors who use remote or off-site data centers in various locations for storage of data such as medical images. The vendors of the cloud-based storage may also provide a common viewing system (“a universal viewer”) that allows the healthcare facilities to retrieve a complete set of the patient's medical data taken or stored at other healthcare facilities through a single request.

### SUMMARY

In general, in one aspect, the invention relates to a method to search, extract, and display medical images and data between a plurality of medical repositories on a plurality of medical servers of healthcare facilities within a network. The plurality of medical servers are connected through a data integration controller and comprises a local medical server and two or more remote medical servers. The method comprises causing the local medical server to: transmit a search request by a user to the plurality of remote medical servers, wherein the search request comprises a search key associated with a predetermined patient; receive and display medical information associated with the search request from the plurality of remote medical servers, wherein the medical information is organized into a user-selectable interface by the data integration controller; transmit, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user; receive the medical data associated with the medical data retrieval request from the remote medical servers associated with the medical information selected by the user; and display the received medical data to the user.

In general, in one aspect, the invention relates to a non-transitory computer-readable medium (CRM) storing instructions that cause a local medical server coupled to a computer to perform an operation to search, extract, and display medical images and data between a plurality of medical repositories on a plurality of medical servers of healthcare facilities within a network. The plurality of medical servers are connected through a data integration controller and comprises the local medical server and two or more remote medical servers. The operation comprises causing the local medical server to: transmit a search request by a user to the plurality of remote medical servers, wherein the search request comprises a search key associated with a predetermined patient; receive and display medical information associated with the search request from the plurality of remote medical servers, wherein the medical information is organized into a user-selectable interface by the data integration controller; transmit, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user; receive the medical data associated with the medical data retrieval request from the remote medical servers associated with the medical information selected by the user; and display the received medical data to the user.

In general, in one aspect, the invention relates to a system that exchanges medical data between medical severs of healthcare facilities that are part of a network. The system comprises: a local medical server with a medical repository and a data integration controller with a communication interface (I/F) circuit that connects the local medical server with two or more remote medical servers with respective medical repositories. The local medical server: transmits a search request by a user to the plurality of remote medical servers, wherein the search request comprises a search key associated with a predetermined patient; receives and displays medical information associated with the search request from the plurality of remote medical servers, wherein the medical information is organized into a user-selectable interface by the data integration controller; transmits, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user; receives the medical data associated with the medical data retrieval request from the remote medical servers associated with the medical information selected by the user; and displays the received medical data to the user.

Other aspects and advantages of the invention will be apparent from the following description and the appended claims.

### BRIEF DESCRIPTION OF DRAWINGS

FIGS. 1A, 1B, and 1C show a system in accordance with one or more embodiments.

FIG. 2 shows a system diagram in accordance with one or more embodiments.

FIG. 3 shows a diagram in accordance with one or more embodiments.

FIGS. 4A, 4B, and 4C show a user interface in accordance with one or more embodiments.

FIGS. 5A and 5B show a user interface in accordance with one or more embodiments.

FIG. 6 shows a diagram in accordance with one or more embodiments.

FIG. 7 shows a computing system in accordance with one or more embodiments.

FIG. 8 shows a system diagram in accordance with one or more embodiments.

FIGS. 9A and 9B show a flow chart in accordance with one or more embodiments.

FIG. 10 shows a flow chart in accordance with one or more embodiments.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although multiple dependent claims are not introduced, it would be apparent to one of ordinary skill in that that the subject matter of the dependent claims of one or more embodiments may be combined with other dependent claims.

In general, one or more embodiments of the invention provide a method, a non-transitory computer readable medium, and a system configured for searching and extracting medical data (i.e., a patient's complete medical records including all medical images, reports, files, etc.) between healthcare facilities.

With a universal viewer in accordance with one or more embodiments, healthcare facilities that work together as part of a group or network are able to coordinate and deliver a broad spectrum of services to patients of those healthcare facilities. For example, the network may comprise healthcare facilities part of the same hospital group or healthcare facilities within a particular region (e.g., a regional medical network). According to one or more embodiments, healthcare facilities that are part of the network (“in-network healthcare facility”) can more effectively utilize the universal viewer to retrieve medical data for patients who frequent one or more of the in-network healthcare facilities.

According to one or more embodiments, each of the in-network healthcare facilities may be associated with one of a cloud-based storage system, a Picture Archiving and Communication System (PACS), or a cloud-based PACS provided by the same vendor or a different vendor. Specifically, each of the in-network healthcare facilities may utilize a different system for storing medical data and may also utilize a unique network for inter-facility communication. For example, each in-network healthcare facility may have a unique security protocol, data encryption method, and network safety and access protocol.

According to one or more embodiments, in response to a search request from one in-network healthcare facility (“request source facility”), all other in-network facilities (“request target facilities”) will transmit medical information (information associated with the medical data) that closely matches a user-inputted search parameter (“search key”) included in the search request. The search key includes simple information associated with a predetermined patient that can be easily retrieved orally from the patient or from the patient's identification card (ID) (e.g., driver license, passport, physical medical insurance card, digital medical insurance card, etc.) without the use of external physical devices (e.g., biometric scanners, card scanners, etc.) and external media (CDs, DVDs, USBs, external hard drives etc.).

According to one or more embodiments, the medical information includes information associated with the medical data but not the actual medical data. The user may choose to retrieve only medical data that are necessary or is of interest to the user because the complete set of the patient's medical data stored in the medical data repositories or databases (“medical repositories”) of the request target facilities may be too big in size and not all of the data may be required by the user. For example, a user may not want to retrieve medical data that are outdated, related to a diagnosis that would not be useful for the current diagnosis, or related to a different patient. This not only prevents unnecessary storage cost on the medical repository at the healthcare facility that transmits the request, but also decreases the amount of time required to retrieve the medical data.

According to one or more embodiments, in the event that a patient's medical data is updated at any one of the multiple in-network healthcare facilities, the universal viewer displays a message to notify all other in-network healthcare facilities that have previously retrieved the medical data. The universal viewer then presents the user with the option to retrieve and view the updated data. For example, if a user at Facility A updates a medical data that was previously retrieved by a user at Facility B, the user at Facility B will automatically be notified of the change and given the option to retrieve and view the updated data from Facility A. This enables all of the users among the in-network healthcare facilities to be provided with the most recent and up-to-date medical data.

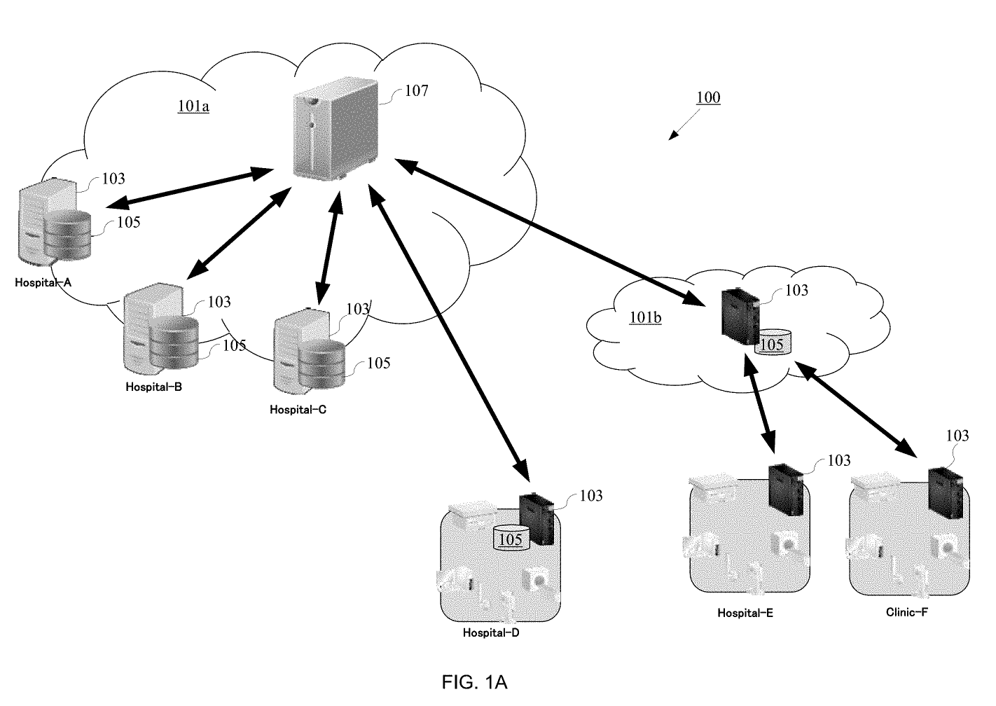

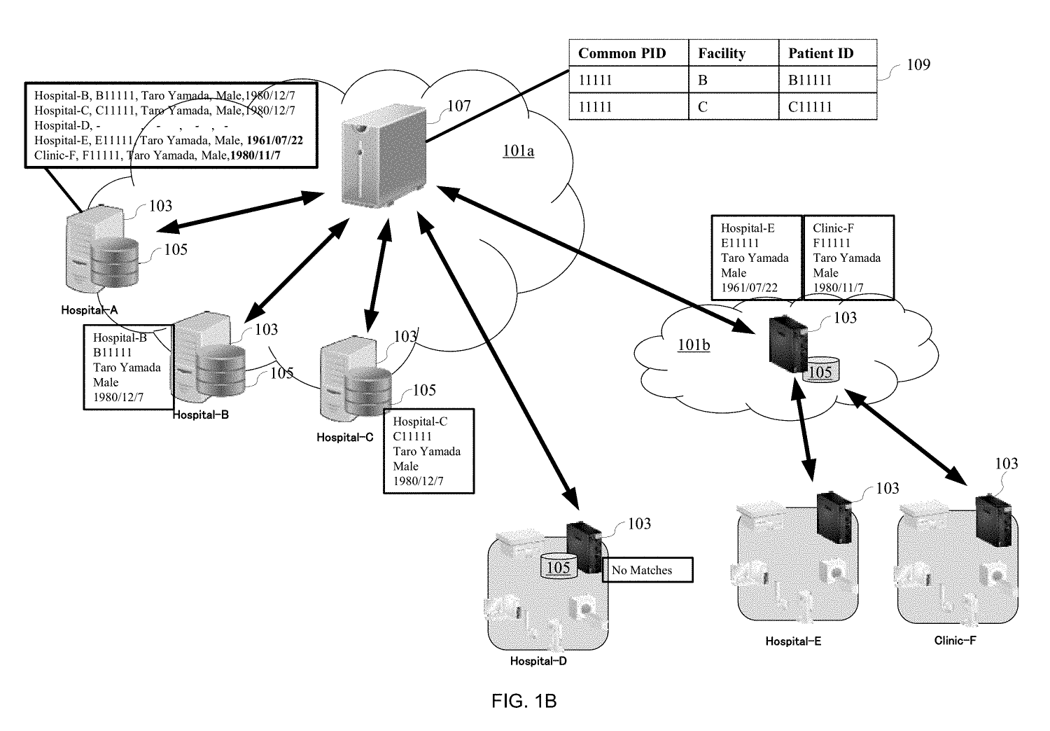

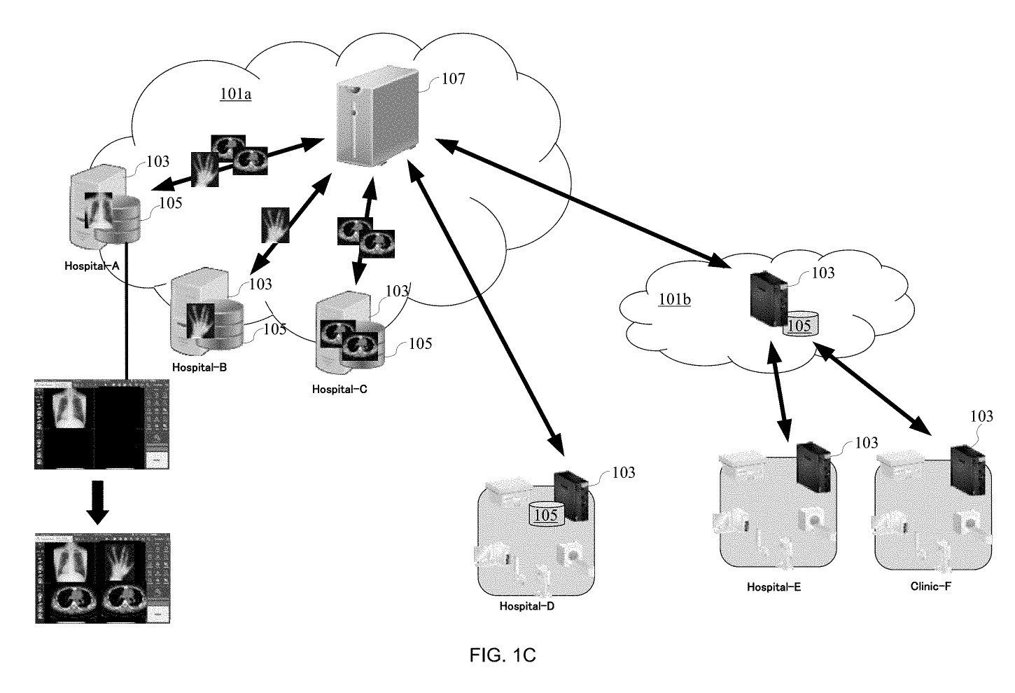

FIGS. 1A, 1B, and 1C show a system (100) in accordance with one or more embodiments of the invention. As shown, the system (100) includes multiple clouds (101a, 101b), multiple medical servers (103) (e.g., application proxy servers (APS)) with medical repositories (105) associated with different in-network healthcare facilities (Hospitals A-E and Clinic F), and a data integration controller (107). The medical servers (130) are all coupled to and configured to communicate bilaterally with the data integration controller (107). In addition, the medical servers (130) may exchange medical data with each other through the data integration controller (107). Each of the healthcare facilities may be any type of facility that provides medical care such as a public hospital, a private hospital, a medical clinic, a dental clinic, etc.

In one or more embodiments, each of the medical servers (103) is coupled to multiple user computing devices (not shown) (herein referred to as “a local computer”) that are used by healthcare professionals at each in-network healthcare facility. Each local computer may correspond to a personal computer (PC), a laptop, a mobile computing device (e.g., tablet PC, smartphone, etc.), a server, a mainframe, a kiosk, etc.

The multiple medical servers (103) may be coupled to the same cloud (101a), to a different cloud (101b), or to no cloud. Specifically, in the example shown in FIGS. 1A, 1B, and 1C, the medical servers (103) of Hospital A, Hospital B, and Hospital C share a common cloud (101a) (herein referred to as “a shared cloud server”) provided by the same vendor. The medical server (103) of Hospital D is not disposed on either the cloud (101a) or the cloud (101b). The medical server (103) of Hospital D is disposed locally in Hospital D and may be a medical server associated with a PACS provided by a vendor different from the vendor of the cloud (101a) and the vendor of the cloud (101b). The medical servers (103) disposed locally in Hospital E and Clinic F may communicate bilaterally with the medical server (103) disposed on the cloud (101b) that is different from the cloud (101a) that hosts the medical servers (103) of Hospitals A to C. Medical data stored in the medical server (103) disposed on the cloud (101b) is different from the medical data stored in the medical servers (103) disposed locally in Hospital E and Clinic F. Specifically, copies of all of the medical data stored in the medical servers (103) in Hospital E and Clinic F are backed-up and available in the medical server (103) disposed in the cloud (101b). The cloud (101b) may be associated with a cloud-based PACS provided by a vendor that is different from the vendors that provided the cloud server for Hospitals A to C and the PACS for Hospital D.

In one or more embodiments, the shared remote medical server (103) of Hospital E and Clinic F includes a shared remote repository (105) that may be operated by the same vendor providing the cloud-based PACS or another third-party associated with such a vendor. In one or more embodiments, the shared remote medical server (103) is a physical and/or virtual computing infrastructure that performs application and information processing. For example, the shared remote medical server (103) may be a virtual server or a physical server accessed remotely via the Internet. In one or more embodiments, the remote medical repository (105) is an online repository of data. For example, the remote medical repository may be a virtual data room (VDR) or a database (or group of databases) accessed remotely via the Internet.

In one or more embodiments, the data integration controller may be disposed on the cloud (101b), the cloud (101b), or another cloud (not shown) within the system. The data integration controller may also be provided locally at each in-network healthcare facility. The data integration controller (107) is configured as a hub for inter-connecting the medical servers (103) and for relaying requests and medical data between the medical servers (103). In addition, the data integration controller (107) may be a computing device that includes one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities.

In one or more embodiments, each of the medical servers (103) may be on a different internet network (“network”), which in turn may be different from the network of the data integration controller (107). The network used by the medical servers (103) may depend on the service provided by the vendors associated with the in-network healthcare facility's storage and inter-facility communication system. Therefore, the medical servers communicate with the data integration controller (107) through a gateway (not shown). The gateway may be a separate device, such as simple router, that connects and passes data between two different devices connected on different networks. In one or more embodiments, the medical server may be configured as the gateway device.

In one or more embodiments, the users at the in-network healthcare facilities (e.g., the healthcare professionals) may access the data integration controller (107) through a universal viewer application (“universal viewer”), which may be provided by the same vendor that provided the cloud and/or PACS service, or a different third-party. The universal viewer may be stored on all of the medical servers (103) and may be downloaded to the local computers as a plug-in of a web-browser application with a graphical user interface (“GUI”) that allows the users to operate the universal viewer. Alternatively, the universal viewer may be stored in the data integration controller and may be accessed as a web page by inputting a uniform resource locator (URL) (e.g., a web address) associated with the universal viewer into the search bar of the web-browser.

FIG. 1B shows an example in accordance with one or more embodiments of the invention. In this example, Hospital A sends a first request for medical information associated with a predetermined patient, using as the search criteria the patient's first name (Taro), last name (Yamada), gender (Male), and date of birth (1980/12/7). Further, Hospitals B and C have medical data with information that exactly matches the information of the predetermined patient in the request sent by Hospital A. Further still, Hospital D has no matches, and Hospital E and Clinic F have medical data with information that matches the name and gender but not the date of birth of the predetermined patient in the request sent by Hospital A. Upon receipt of the request from Hospital A that was forwarded through the data integration controller (107), the other facilities transmit medical information associated with these medical data to the data integration controller (107).

In one or more embodiments, upon receipt of the medical information transmitted from Hospitals B-E and Clinic F, the data integration controller (107) organizes the received medical information into a list and transmits the list to the medical server (103) of Hospital A where the list is then displayed to the user, e.g., through a web-browser on a local computer at Hospital A. The user can view the list compiled by the data integration controller (107) and select only the relevant medical data or only the medical data of interest. For example, as seen in FIG. 1B, the medical data associated with the medical information that does not match the initial request would likely be irrelevant to the user.

In one or more embodiments, once the user selects the medical information of interest from the list, the user transmits a second request to the data integration controller (107) to retrieve the medical data from the facilities that have the medical data of interest. In the example shown in FIG. 1B, the user is only interested in the medical data from Hospitals B and C, which sent the medical information that match up exactly with the predetermined patient's information. Therefore, the data integration controller (107) only sends retrieval requests to the medical servers (103) of Hospitals B and C.

In one or more embodiments, in response to the request to retrieve the medical data, the medical servers (103) of Hospitals B and C transmit the medical data requested by Hospital A to the data integration controller (107). The data integration controller (107) receives the medical data from Hospitals B and C and creates a data table (109) to store the medical information of the received medical data under a newly created common patient ID (“common HD”). The data table (109) is then saved in the data integration controller (107). The medical data is then forwarded to Hospital A where the medical data is combined with any relevant data medical data pre-existing in Hospital A and displayed by to the user.

FIG. 1C shows an example in accordance with one or more embodiments of the invention. In this example, Hospital A sends a request through the data integration controller (107) as described in the example of FIG. 1B. Hospital A receives the medical data from Hospitals B and C. Hospital A combines the received medical data with a pre-existing medical data, and then displays the combined medical data to the user through the universal viewer using, e.g., a web-browser.

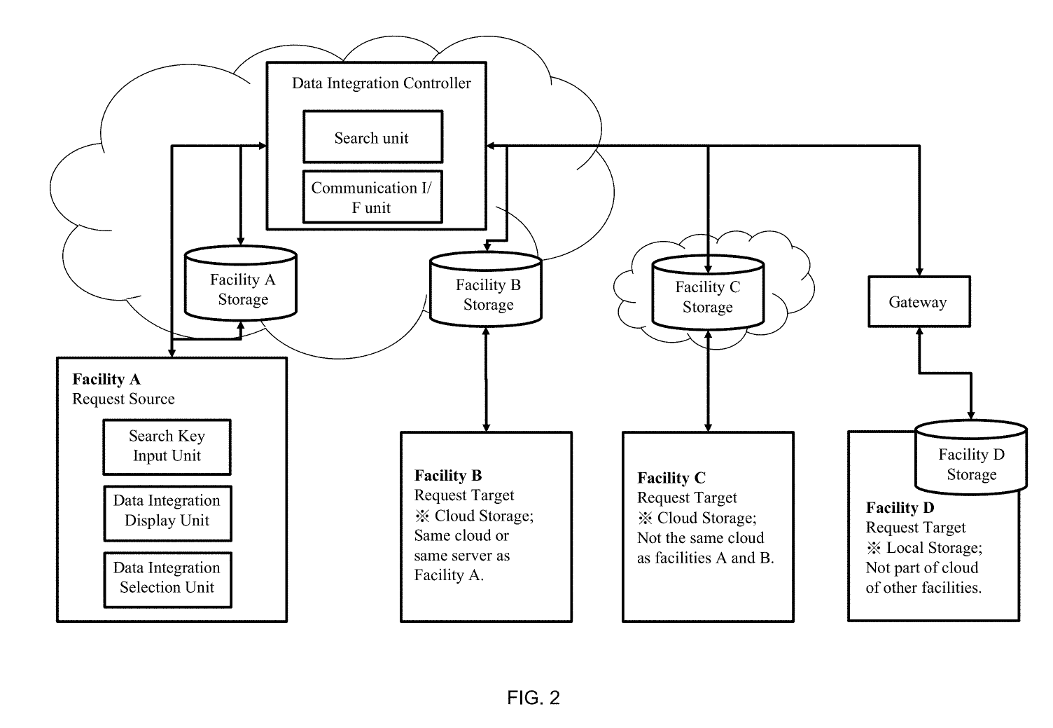

FIG. 2 shows a system diagram in accordance with one or more embodiments of the invention. As shown in FIG. 2, the system according to one or more embodiments includes four in-network healthcare facilities (Facility A, Facility B, Facility C, Facility D) that each include a storage. The storage of each facility includes the medical servers (103) with the medical repositories (105) as described in FIG. 1A.

As shown in FIG. 2, Facility A is the facility that sends a search request and a medical data request (“the request source facility”) to the remaining facilities (“the request target facilities”). The request source facility has a local computer that includes a search key input unit (e.g., keyboard, mouse, etc.) for inputting the search parameters that make up the search key, a data integration display unit for integrating the medical data received from the request target facilities, and a data integration selection unit (e.g., processor) for organizing and compiling the medical information received from the request target facilities into a user-selectable list. In one or more embodiments, each of the in-network healthcare facilities may be either the request source facility or the request target facility.

In one or more embodiments, the storage of each facility may be disposed either locally in the respective healthcare facility or remotely on a cloud. As shown in FIG. 2, the storages of Facilities A and B are disposed in the same cloud, the storage of Facility C is disposed in a different cloud, and the storage of Facility D is disposed locally within Facility D. Each of the storages may be associated with a different network. The storages disposed in the same cloud may share the same network.

In the system in accordance with one or more embodiments as shown in FIG. 2, the data integration controller (107) as described in FIG. 1A is disposed in the same cloud as the storages of Facilities A and B. Alternatively, the data integration controller (107) may instead be disposed on a cloud different from the clouds that host the storages of Facilities A, B and C.

In one or more embodiments, the data integration controller (107) includes a search unit that processes the search request (i.e., relays the search request, the medical data request, the medical information, and medical data between the different storages) and a communication I/F (communication interface) unit that is configured as a main gateway that connects all of the storages to a network associated with the data integration controller (107). Each of the storages communicates with the data integration controller through a local gateway that connects each of the storages to the communication I/F unit of the data integration controller (107). The local gateway of each of the four in-network healthcare facilities may be the medical servers (103) that are part of the storages or may be a separate device.

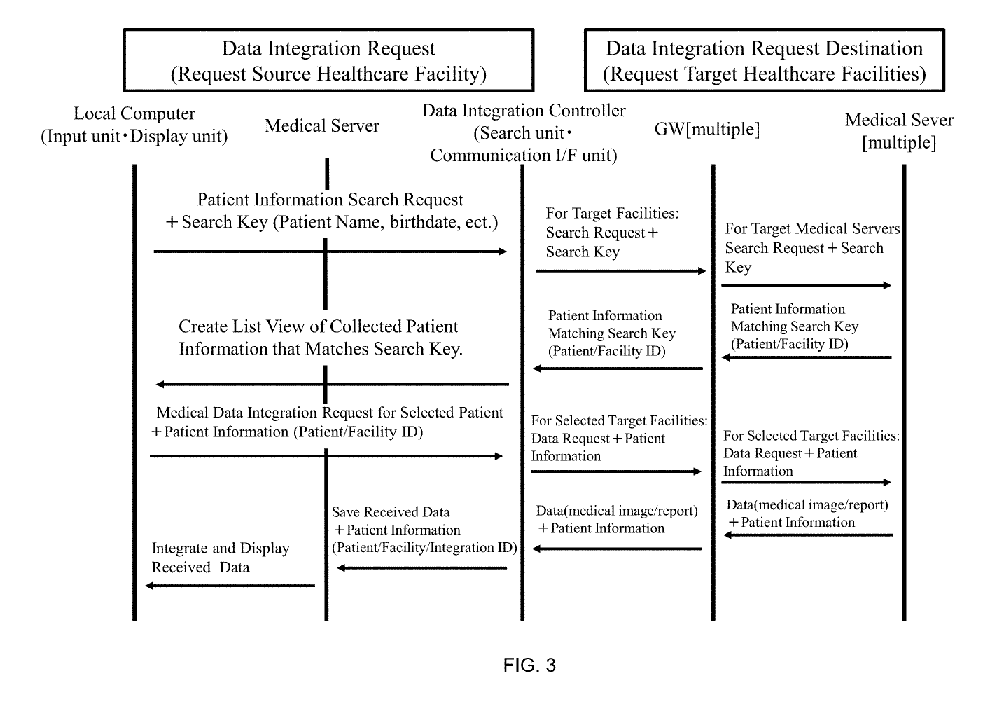

FIG. 3 shows a communication diagram in accordance with one or more embodiments of the invention. The communication diagram illustrates a communication method of one or more embodiments that is implemented by the system as shown in FIG. 2. The communication diagram illustrates the path of the signals transmitted in response to a request from one of the in-network healthcare facilities to retrieve medical data (“a data integration request”).

In one or more embodiments as shown in FIG. 3, the data integration request originates from a local computer of a source healthcare facility (the request source facility as described in FIG. 2). The data integration request is initially sent as a patient information search request (“search request”) from the local computer coupled to a medical server at the request source facility to the data integration controller. The search request includes a search key made up of a string of patient information associated with a predetermined patient. The patient information may include the patient's name, gender, and date of birth; the facility identification (ID) of the healthcare facilities associated with the patient; the type of modalities used for the patient's diagnosis; etc.

In one or more embodiments, the data integration controller receives the search request and relays the search request to the medical servers of a data integration request destination (the request target facilities as described in FIG. 2). The medical servers of the request target facilities may receive the search request through local gateway devices coupled to the medical servers. In one or more embodiments, the medical servers may be configured as the local gateway.

In one or more embodiments, the medical servers of the request target facilities process the received search request and transmit medical information that matches the search request to the data integration controller. The data integration controller receives the medical information from the request target facilities, compiles the medical information into a list, and transmits the list to the local computer of the request source facility.

In one or more embodiments, the local computer displays the received list of medical information to the user. The user selects the medical data associated with the received medical information that the user wants to integrate (i.e., retrieve). Once the user confirms the medical data to be integrated, the local computer transmits a medical data retrieval request (“a retrieval request”) to the data integration controller. The data integration controller processes the retrieval request and transmits the retrieval request to the medical servers of selected request target facilities associated with the requested data (i.e., the request is only transmitted to the target facilities that have the requested medical data).

In one or more embodiments, the selected target facilities receive and process the retrieval request and transmit the requested medical data to the data integration controller. The data integration controller receives the requested medical data from the selected request target facilities and forwards the medical data to the medical server of the request source facility. The request source facility receives the medical data from the data integration controller, saves the received medical data, integrates received data into a single file, and displays the integrated medical data on the local computer.

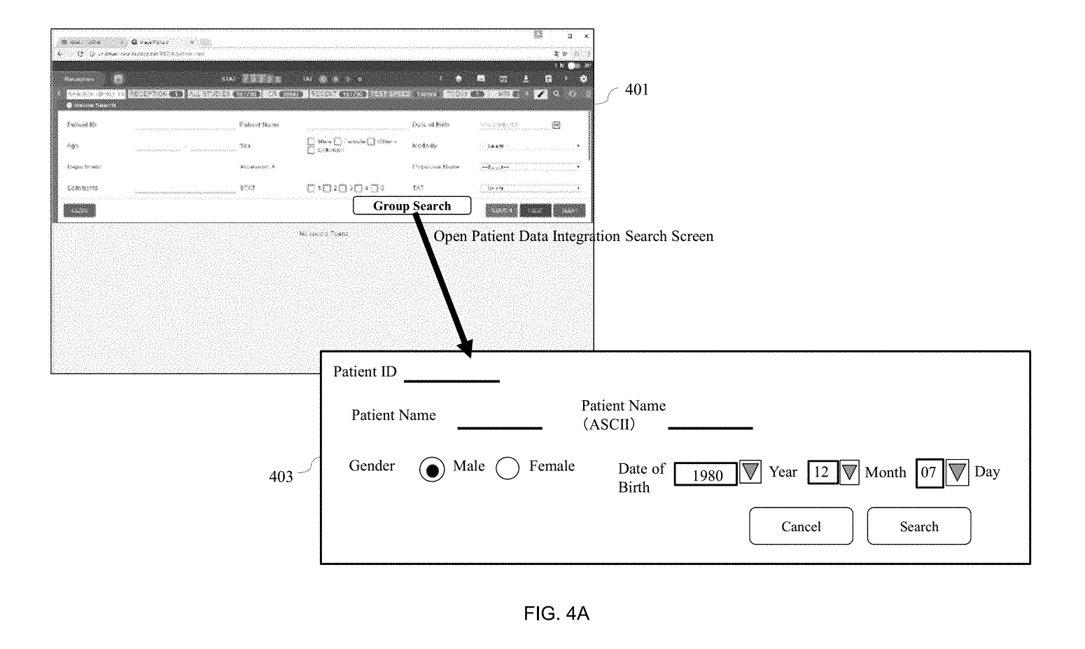

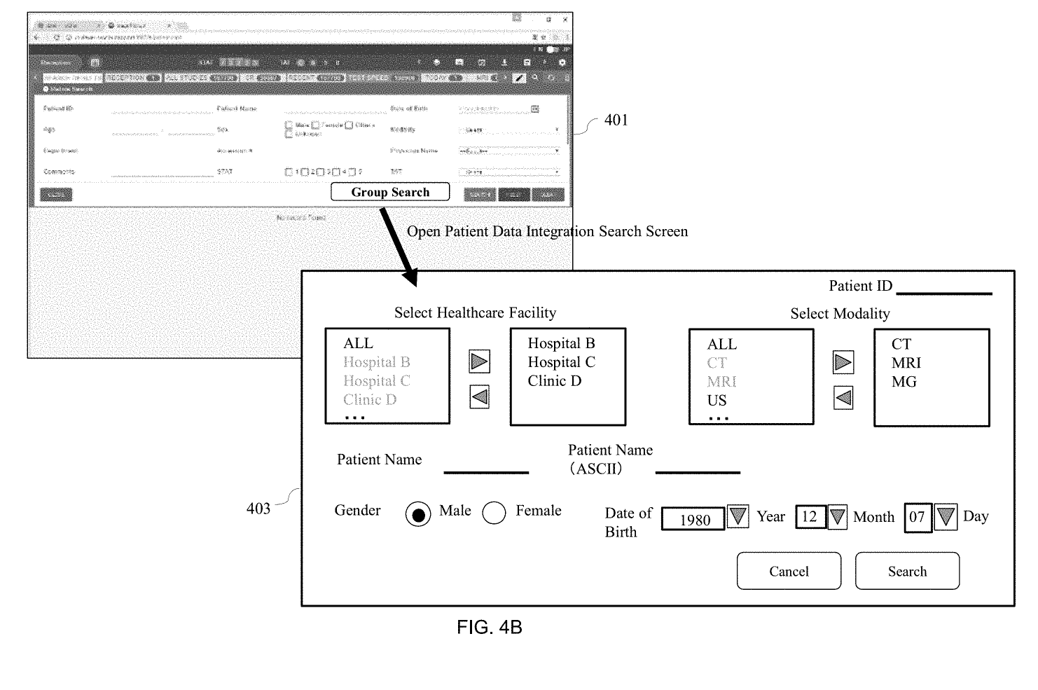

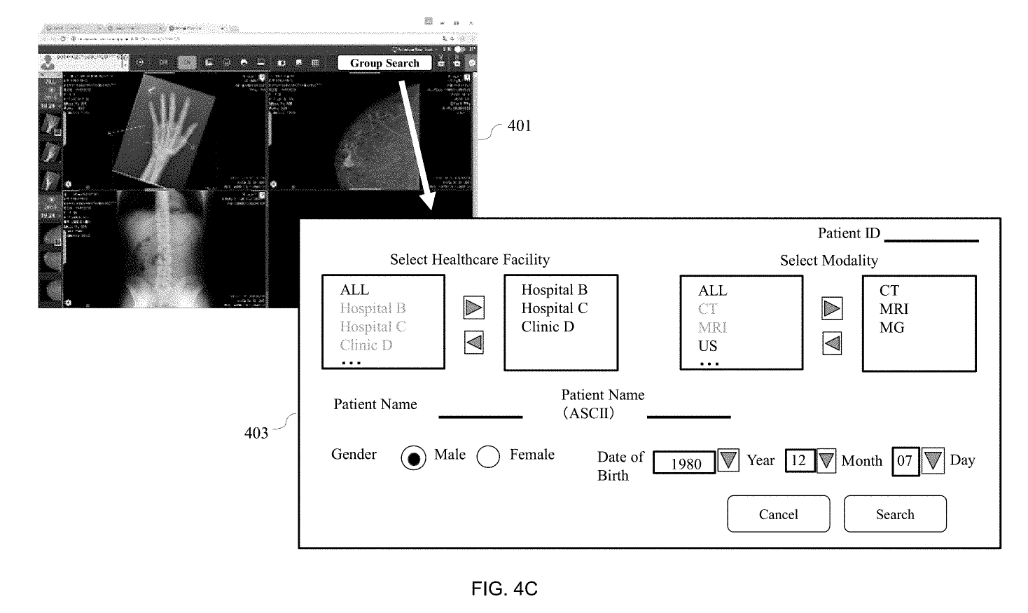

FIGS. 4A, 4B, and 4C show a user-interface in accordance with one or more embodiments of the invention. As shown is FIGS. 4A to 4C, the user may access the universal viewer through a web-browser (401). The universal viewer in this example includes a search option that, when selected by the user, opens a Patient Data Integration Search Screen (“a search interface”) (403) to the user.

In one or more embodiments, as shown in FIG. 4A, an initial start-up page of the universal viewer may be displayed in a tab of the web-browser (401). The user of the universal viewer may access the start-up page by entering the web address associated with the universal viewer into the search bar of the web-browser (401).

In one or more embodiments, the user may be prompted to enter access information that includes a designated USER ID and a user-set PASSWORD that indicates that the user has authorization to access the universal viewer. The user may only be prompted to enter access information when the universal viewer is opened for the first time since the web-browser (401) was last closed by the user. In one or more embodiments, the user may be prompted to enter the access information every time the user opens the universal viewer.

In one or more embodiments, the user may also open multiple tabs and access the universal viewer through all of the opened tabs. Each of the universal viewers opened in each tab of the web-browser (401) is independent of each other. For example, changes made by the user to the universal viewer in one tab would not be applied to the universal viewer opened on a different tab.

In one or more embodiments, the search interface (403) as shown in FIG. 4A includes search parameters that make up the search key included in the user's search request. The search interface (403) includes a parameter for inputting a Patient ID, a Patient Name in regular alphabets, a Patient Name in ASCII format, and parameters for selecting a patient's gender, and the year, month, and day of the patient's date of birth. The search interface (403) further includes two user-selectable tabs to either cancel (CANCEL) the search request (i.e., close out of the search interface) or submit the search request (SEARCH). In one or more embodiments, the search parameters may be manually entered by the user on the search interface (403). Alternatively, in the event that the user opens the search interface when information on the patient of interest has already been loaded on the web-browser (401), the parameters of the search interface (403) will be automatically completed (i.e., automatically filled in by the universal viewer) based on the patient information loaded on the web-browser (401).

In one or more embodiments, not all of the parameters in the search interface (403) need to be completed by the user in order for the user to submit the search. For example, the user may submit the search request with only the date of birth of the patient or with only the combination of the patient name and the patient's gender. One of ordinary skill would appreciate that as more parameters in the search interface (403) are filled, a more refined search will be conducted by the universal viewer application.

In one or more embodiments as shown in FIG. 4B, the search interface (403) may also include more advanced search parameters such as a parameter for selecting the target in-network healthcare facilities (“request target facilities”) that will receive the search request, and a parameter for selecting the modality that acquired the medical data. As shown in FIG. 4B, Hospital B, Hospital C, and Clinic F are selected as target facilities that will receive the search request, and the search request is directed to medical data associated with the CT, MRI, and. MG modalities. One of ordinary skill would appreciate that various other search parameters may be used that are not specifically shown, e.g., the patient's blood type.

In one or more embodiments as shown in FIG. 4C, the user may access the search interface (403) at any time through the universal viewer application. In the example of FIG. 4C, the web-browser (401) is displaying a patient diagnosis tab that includes multiple medical data currently being viewed by the user.

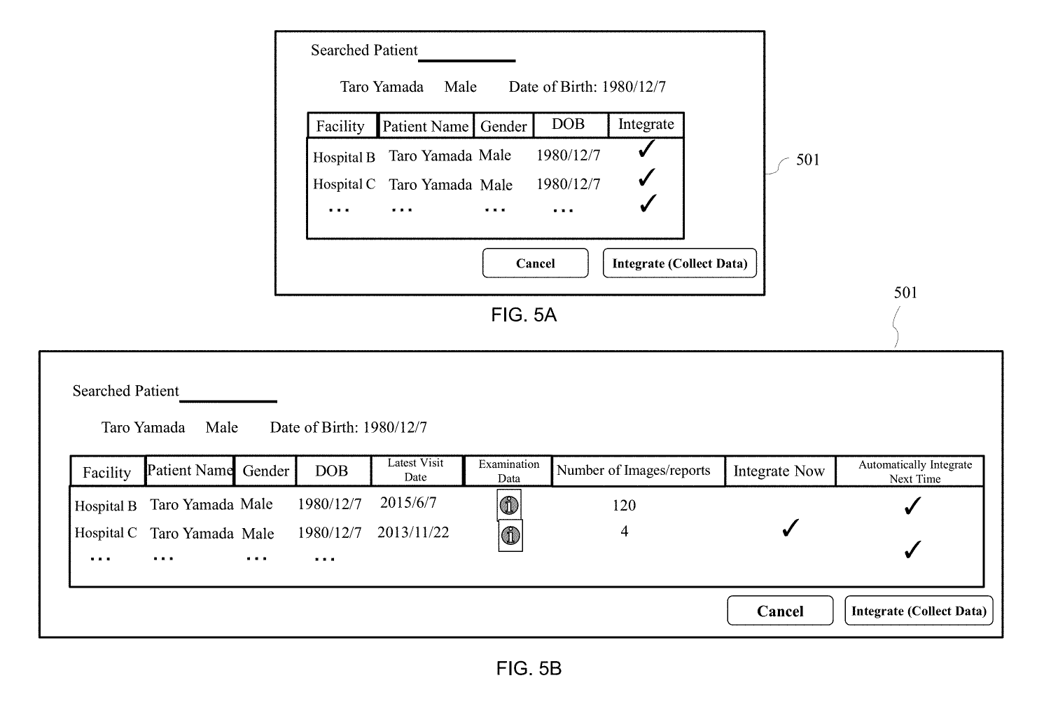

FIGS. 5A and 5B show a user-interface (501) that includes the list of medical information compiled by the data integration controller (107) in accordance with one or more embodiments of the invention. As shown in FIG. 5A, the user-interface (501) includes the information (e.g., the patient's name, the patient's gender, the patient's date of birth) of the predetermined patient entered in the search request (“search request”). The user-interface (501) further displays the list of medical information and sorts the medical information by Facility, Patient Name, Gender, Date of Birth (“DOB”). In addition, the user-interface (501) includes an option for the user to select all of the medical information of interest from the list (i.e., the integrate column). Once the user selects all the medical information of interest, the user may either submit the search request (SEARCH) or cancel (CANCEL) the search request (i.e., close out of the search interface).

FIG. 5B shows an example of the user-interface (501) in accordance with one or more embodiments of the invention. The user-interface (501) as shown in FIG. 5B displays additional information such as a Patient's Latest Visit Date, information on the Examination Data, and the Number of Images/Reports in the medical data. In one or more embodiments, clicking on the icon in the Examination Data column will open a pop-up window displaying detailed information on the diagnosis related to the medical information. Additionally, the user-interface in this example further includes an option for select medical information which the user wants to retrieve immediately (Integrate Now) and an option for selecting which medical information that will automatically retrieved next time the same search request is sent (Automatically Integrate Next Time).

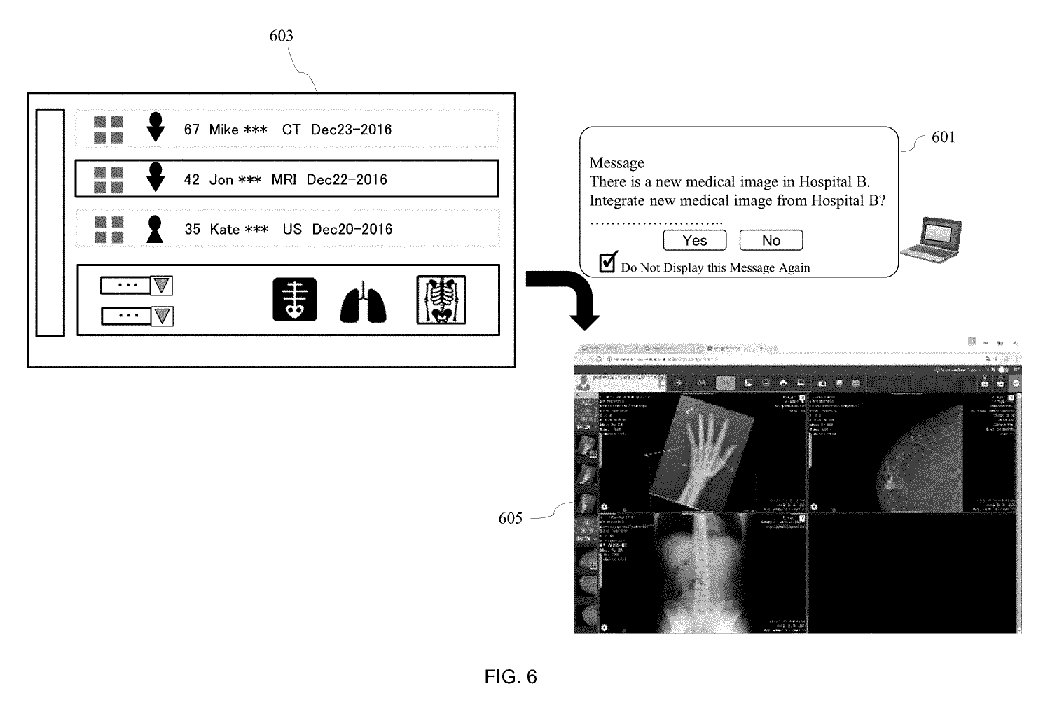

FIG. 6 shows a diagram in accordance with one or more embodiments of the invention that illustrates an event where one of the in-network healthcare facilities updates a medical data or adds medical data associated with a patient whose medical data was retrieved by one or more different in-network healthcare facilities.

In one or more embodiments, information of the search parameters associated with patients whose medical data have been previously retrieved are saved so that, at the time a user logs-in to the universal viewer, the universal viewer will automatically perform a search in the background using the saved search parameters. In the event that the universal viewer determines that one of the network healthcare facilities has updated an existing medical data or added a new medical data associated with a previously searched patient, the universal viewer will display a pop-up display (601) to the user to indicate that medical data associated with a previously search patient has been changed. In one or more embodiments, the automatic search conducted in the background may also be performed by the universal viewer at predetermined intervals based on a user preference when the universal viewer is open.

In one or more embodiments as shown in FIG. 6, the universal viewer will display the pop-up display message (601) to a user at one or more in-network healthcare facilities that have retrieved medical data associated with a patient (e.g., Jon Doe with a date of birth of Dec. 22, 2016). The pop-up display message (601) indicates that Hospital B has updated the medical data (i.e., added new medical data or modified medical data) associated with the same patient. The pop-up display message (601) asks the user whether the user would like to integrate (i.e., retrieve) the updated medical data from Hospital B. The user is also presented with an option to stop the universal viewer from displaying such a message again in the future for the same patient.

In one or more embodiments, if the user chooses to integrate the updated medical data, the universal viewer will retrieve the updated medical data from Hospital B, save the updated medical data in the healthcare facility's medical repository, and indicate through user-interface (603) that updated medical data is available for the patient. The user may then select the patient from the user-interface (603) to see what new medical data is available. As shown in FIG. 6, the type of medical data available is represented through thumbnail versions of medical images. The user may then decide whether to open the updated medical data to view the updated medical data in the web-browser (605).

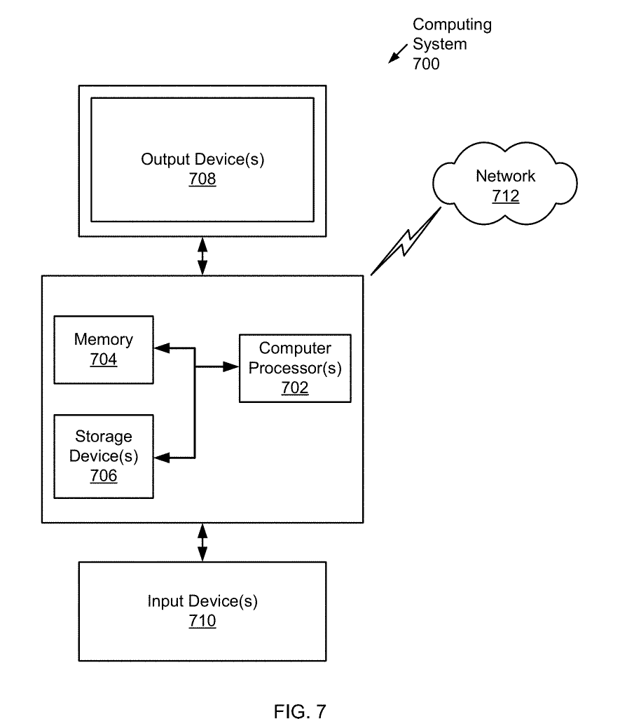

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 7, the computing system (700) may include one or more computer processor(s) (702), associated memory (704) (e.g., random access memory (RAM), cache memory, flash memory, etc.), one or more storage device(s) (706) (e.g., a hard disk, an optical drive such as a compact disk (CD) drive or digital versatile disk (DVD) drive, a flash memory stick, etc.), and numerous other elements and functionalities. The computer processor(s) (702) may be an integrated circuit for processing instructions. For example, the computer processor(s) may be one or more cores, or micro-cores of a processor. The computing system (700) may also include one or more input device(s) (710), such as a touchscreen, keyboard, mouse, microphone, touchpad, electronic pen, or any other type of input device. Further, the computing system (700) may include one or more output device(s) (708), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (700) may be connected to a network (712) (e.g., a local area network (LAN), a wide area network (WAN) such as the Internet, mobile network, or any other type of network) via a network interface connection (not shown). The input and output device(s) may be locally or remotely (e.g., via the network (712)) connected to the computer processor(s) (702), memory (704), and storage device(s) (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (700) may be located at a remote location and connected to the other elements over a network (712). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

The computing system of FIG. 7 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

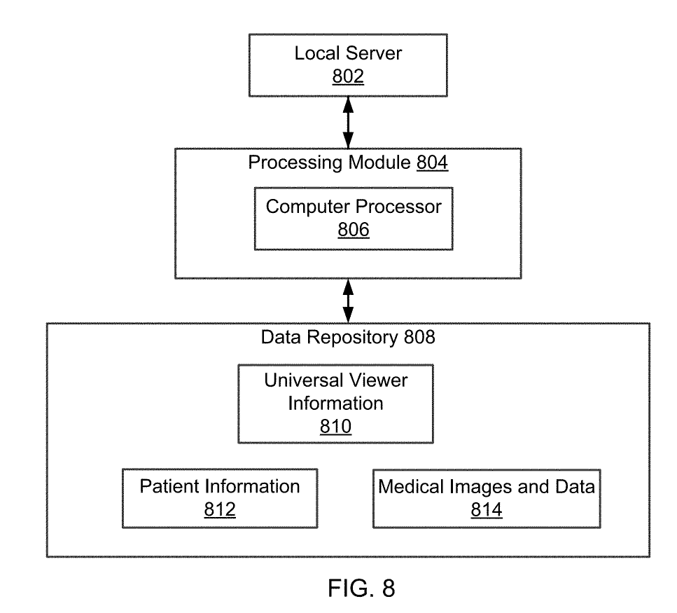

FIG. 8 shows a schematic diagram of a system in accordance with one or more embodiments. The system is configured for searching, extracting, and displaying medical images and data between a plurality of medical repositories on a plurality of medical servers of healthcare facilities within a network. The plurality of medical servers are connected through a data integration controller and comprises a local medical server and two or more remote medical servers.

The system as shown in FIG. 8 may include, for example, (i) a processing module (804) including a computer processor (806) configured to execute instructions configured to perform the following steps.

In one aspect, the computer processor (806) executes instructions to (1) transmit a search request by a user to the plurality of remote medical servers, wherein the search request comprises a search key associated with a predetermined patient, (2) receive and display medical information associated with the search request from the plurality of remote medical servers, wherein the medical information is organized into a user-selectable interface by the data integration controller, (3) transmit, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user, (4) receive the medical data associated with the medical data retrieval request from the remote medical servers associated with the medical information selected by the user, (5) display the received medical data to the user, and (6) display, when the received medical data has been updated by any one of the remote medical servers associated with the medical information selected by the user, a message to the user that the received medical data has been changed.

The system as shown in FIG. 8 further comprises (ii) a local server (802) configured to present the medical data to the user. The system may further include a repository (818) configured to store a universal viewer application data (810) related to the vendor provided application, the patient associated information (812), and the medical data (814).

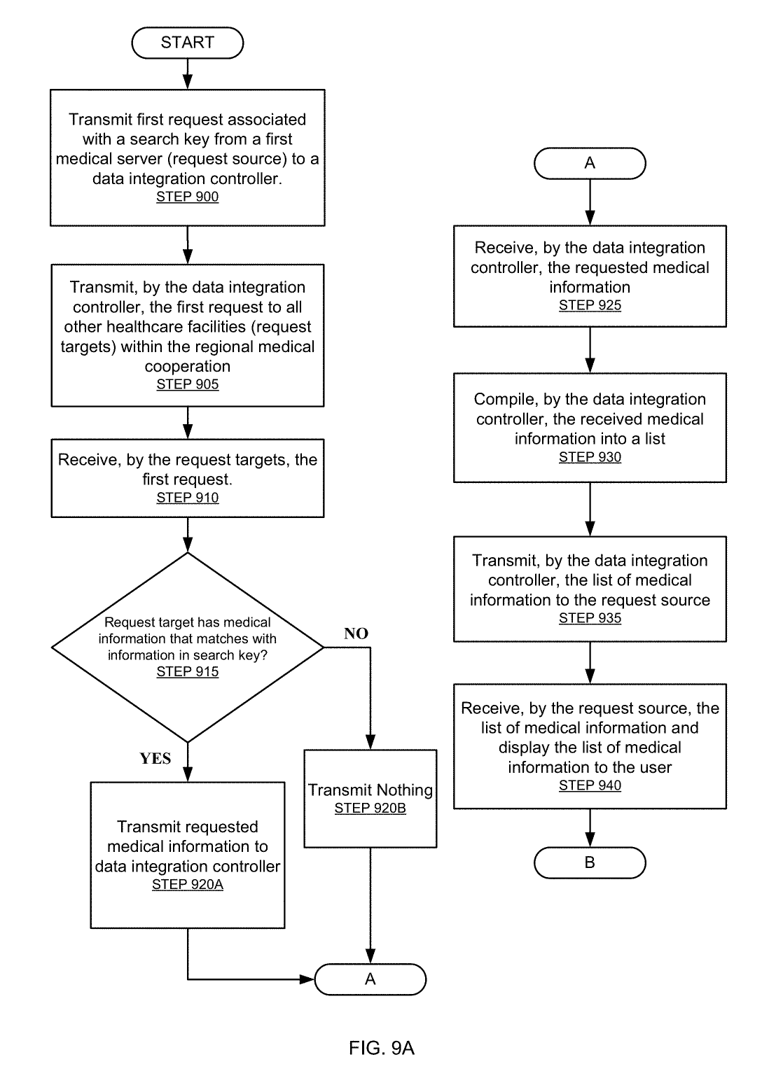

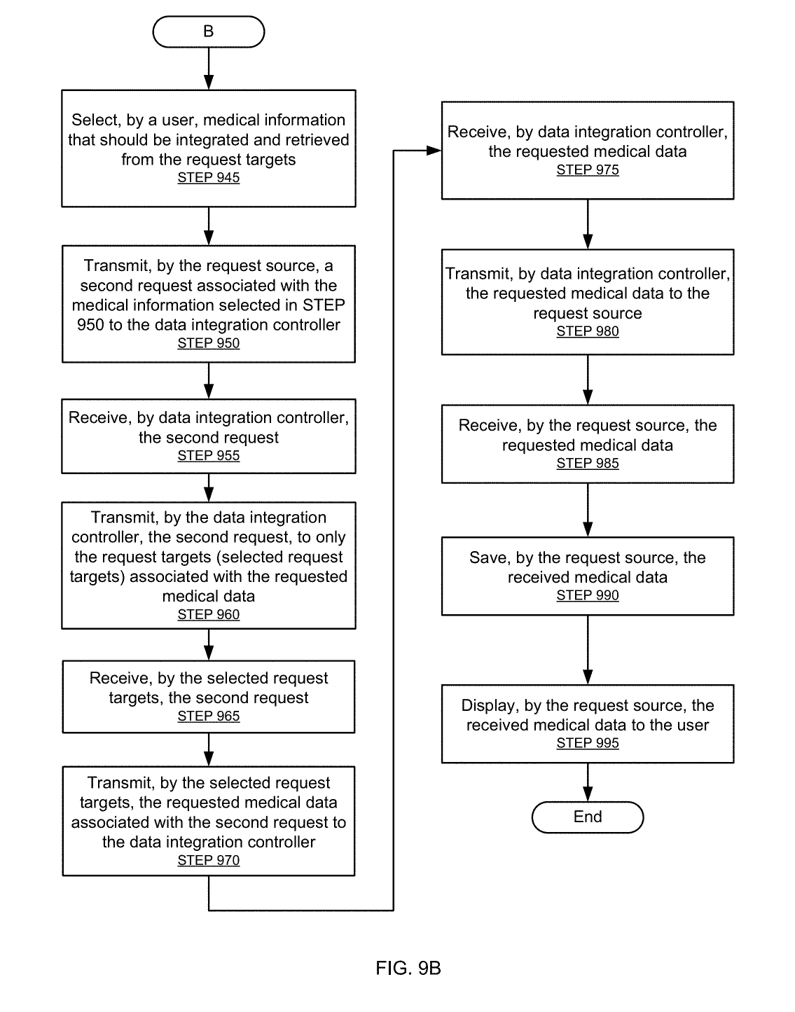

FIGS. 9A and 9B show a flowchart of a method in accordance with one or more embodiments. In one or more embodiments, the method as shown in FIGS. 9A and 9B is a computer-implemented method. Each step shown in FIGS. 9A and 9B are described together below with respect to only a system of one healthcare facility among the multiple in-network healthcare facilities. It would be apparent to one of ordinary skill in the art that each step of the method described below can be performed by any of the systems of the multiple in-network healthcare facilities.

In Step 900, a patient information search request (“a search request”) is transmitted from a medical server in one of the multiple in-network healthcare facilities (“a request source”) to the data integration controller. The search request includes a search key associated with information of a predetermined including the patient's name, the patient's gender, and the patient's date of birth. The user enters in the search information through the universal viewer opened in a web-browser.

In Step 905, the data integration controller receives the search request from the request source and transmits the search request to all other medical servers of the other in-network healthcare facilities (“request targets”) that are connected to the data integration controller.

In Step 910, the request targets receive the search request and each request target determines in Step 915 if their respective medical servers contain medical data with medical information that matches with the patient information included in the search key. In one or embodiments, the medical data must have medical information that matches any number of the patient information included in the search key as long as the results are sufficient to identify the patient of interest accurately with confidence. For example, a match of at least two general search parameters such as gender and either one of a first name or a last name with at least one other more specific parameter such as the patient's full legal name, date of birth, modality type, or facility ID may be required. One of ordinary skill would appreciate that various other combinations may be used that are not specifically shown, e.g., more than two general parameters without a specific parameter, one general parameter with two specific parameters, only two specific parameters, etc.

For the respective request target, if the result in the check in Step 915 is NO, the request target transmits nothing in Step 920B.

If the result in the check in Step 915 is YES, the request target transmits the medical information that matches the patient information included in the search request to the data integration controller. In one or more embodiments, the medical information does not include the actual medical data but rather includes information about the medical data such as Facility Name, Patient Name, Patient Gender, Patient Date of Birth, Latest Visit Date, Examination Data, Number of Images/Reports, etc.

In Step 925, the data integration controller receives the medical information from all the request targets that produced a YES result in STEP 915. All of the medical information received by the data integration controller is then compiled by the data integration controller into a list-view format in Step 930.

In Step 935, the data integration controller transmits the compiled list of medical information to the request source. The request source displays the compiled list of medical information received from the data integration controller on a display screen of a local computer in Step 940.

In Step 945, the user views the received list of medical information and selects all medical information associated with medical data the user wants to retrieve from the request targets. In one or more embodiments, not all of the medical information may be selected. Specifically, not all of the medical information may be relevant or be of interest to the user. For example, the user may not want to retrieve medical data that are outdated, related to a diagnosis that would not be useful for the current diagnosis, or related to a different patient whose information may match part of search key. This not only prevents unnecessary storage cost on the medical repository at the healthcare facility that transmits the request, but also decreases the amount of time required to retrieve the medical data.

In Step 950, the user's selection is transmitted in a medical data retrieval request (“retrieval request”) from the request source to the data integration controller. The data integration controller receives the retrieval request in Step 955, and relays the retrieval requests to only the request targets (“selected request targets”) that contain the requested medical data in Step 960.

In Step 965, the selected request targets receive the retrieval request in from the data integration controller, and in Step 970, transmit the medical data that matches the medical data information in the retrieval request to the data integration controller.

In Step 975, the data integration controller receives the requested medical data transmitted from the selected request targets. In one or more embodiments, upon receipt of all of the requested medical data, the data integration controller creates a data table to store the medical information of the received medical data under a newly created common patient ID (“common PID”). The data table is stored in the data integration controller.

In Step 980, the data integration controller transmits the medical data received from the selected request targets to the request source.

In Step 985, the request source receives the medical data transmitted from the data integration controller, integrates and saves the medical data as a single file in the medical repository of the medical server in Step 990, and displays the received medical data on the display of the local computer in Step 995. In one or more embodiments, the medical data is displayed by the universal viewer through a tab of a web-browser.

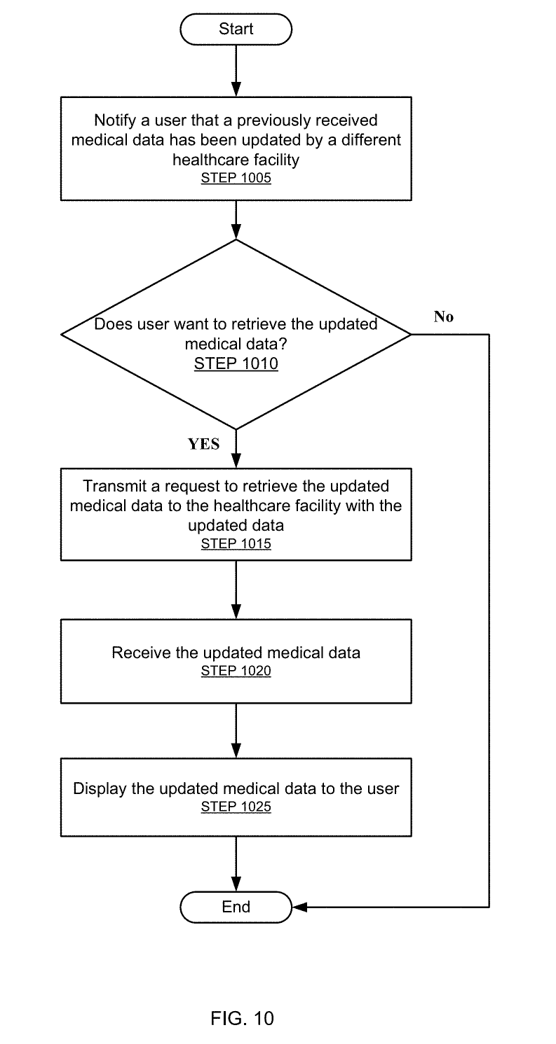

FIG. 10 shows a flowchart of a method in accordance with one or more embodiments. In one or more embodiments, the method as shown in FIG. 10 is a computer-implemented method. Each step shown in FIG. 10 is described together below with respect to only a system of one healthcare facility among the multiple in-network healthcare facilities. It would be apparent to one of ordinary skill in the art that each step of the method described below can be performed by any of the systems of the multiple in-network healthcare facilities.

In Step 1005, a user of a local computer is notified by the universal viewer opened in the local computer through a pop-up display message that a user at a different in-network healthcare facility has added or modified (“updated”) medical data associated with a patient that the present user has previously conducted a search for.

In Step 1010, the local computer receives an input from the user that indicates whether the user wants to retrieve the updated medical data from the other in-network healthcare facility. In one or more embodiments, the local computer simultaneously receives an input from the user that indicates that the user does not want to receive the same message again in the future for the same patient.

If the result of the check in Step 1010 is NO, the process ends. If the result of the check in Step 1010 is YES, the local computer transmits a retrieval request through the medical server to the data integration controller in Step 1015. In one or more embodiments, the data integration controller forwards the request to the in-network healthcare facility that contains the updated data.

In Step 1020, the local computer receives the requested data from the in-network healthcare facility that contains the updated data, and the updated medical data is displayed to the user in Step 1025.

One or more embodiments of the invention may have one or more of the following advantages: the ability to conduct a search for a patient's medical information with only simple information associated with the patient; the ability to retrieve medical data from all healthcare facilities that are part of a network even though each healthcare facility may implement a different medical data storage system and utilize a different type of network; the ability to provide healthcare professionals to choose which medical data to retrieve; the ability to prevent a huge burden being placed on the connection between the in-network healthcare facilities and the medical servers and medical repositories of each in-network healthcare facilities by not retrieving medical data that is not required by a user; etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to search, extract, and display medical images and data between a plurality of medical repositories on a plurality of medical servers of healthcare facilities within a network, wherein the plurality of medical servers are connected through a data integration controller and comprises a local medical server and two or more remote medical servers, the method comprising causing the local medical server to:
transmit a search request by a user to the plurality of remote medical servers, wherein the search request comprises a search key associated with a predetermined patient;
receive and display medical information associated with the search request from the plurality of remote medical servers, wherein the medical information is organized into a user-selectable interface by the data integration controller;
transmit, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user;
receive the medical data associated with the medical data retrieval request from the remote medical servers associated with the medical information selected by the user; and
display the received medical data to the user.

2. The method according to claim 1, wherein each of the plurality of medical servers are coupled to a local computer.

3. The method according to claim 1, further causing the local medical server to display, when the received medical data has been updated by any one of the remote medical servers associated with the medical information selected by the user, a message to the user that the received medical data has been changed, and wherein the message to the user includes an option for the user to retrieve and view the updated medical data.

4. The method according to claim 1, wherein each of the healthcare facilities within the network is associated with a Picture Archiving and Communication Systems (PACS), a cloud-based PACS, or a shared cloud server.

5. The method according to claim 3, wherein the data integration controller is disposed in one of the PACS, the cloud-based PACS, or the shared cloud server of the healthcare facilities within the network.

6. The method according to claim 1, wherein each of the plurality of medical servers of the healthcare facilities within the network communicate bilaterally with the data integration controller through a gateway.

7. The method according to claim 4, wherein
the gateway of the healthcare facilities associated with the PACS is a local server disposed within the healthcare facilities,
the gateway of the healthcare facilities associated with the cloud-based PACS is a remote server disposed on a cloud of the cloud-based PACS, and
the gateway of the healthcare facilities associated with the shared cloud server is the shared cloud server.

8. The method according to claim 1, wherein the search key comprises information related to a name of a patient, a gender of the patient, and a data of birth of the patient.

9. The method according to claim 5, wherein the search key further comprises information related to at least one healthcare facility among the healthcare facilities within the network and at least one type of modality.

10. The method according to claim 1, wherein the user-selectable interface includes
information comprising a facility ID, a patient name, a patient gender, and a patient date of birth, and
an option for the user to select the medical information to be sent in the integration request.

11. The method according to claim 8, wherein the user-selectable interface further includes
information comprising a final visit date, an examination data, a number of inspection images,
an option for the user to select the medical information to be sent in a present integration request, and
an option for the user to select the medical information to be automatically sent in a next integration request.

12. The method according to claim 1, wherein the data integration controller creates a common patient ID for the medical data received by the local medical server and stores the common patient ID in a shared data table stored in the data integration controller.

13. A non-transitory computer-readable medium (CRM) storing instructions that cause a local medical server coupled to a computer to perform an operation to search, extract, and display medical images and data between a plurality of medical repositories on a plurality of medical servers of healthcare facilities within a network, wherein the plurality of medical servers are connected through a data integration controller and comprises the local medical server and two or more remote medical servers, the operation comprising causing the local medical server to:
transmit a search request by a user to the plurality of remote medical servers, wherein the search request comprises a search key associated with a predetermined patient;
receive and display medical information associated with the search request from the plurality of remote medical servers, wherein the medical information is organized into a user-selectable interface by the data integration controller;
transmit, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user;
receive the medical data associated with the medical data retrieval request from the remote medical servers associated with the medical information selected by the user; and
display the received medical data to the user.

14. The CRM according to claim 13, wherein each of the plurality of medical servers are coupled to a local computer.

15. The CRM according to claim 13, further causing the local medical server to display, when the received medical data has been updated by any one of the remote medical servers associated with the medical information selected by the user, a message to the user that the received medical data has been changed, and wherein the message to the user includes an option for the user to retrieve and view the updated medical data.

16. The CRM according to claim 13, wherein each of the healthcare facilities within the network is associated with a Picture Archiving and Communication Systems (PACS), a cloud-based PACS, or a shared cloud server.

17. A system that exchanges medical data between medical severs of healthcare facilities that are part of a network, comprising:
a local medical server with a medical repository; and
a data integration controller with a communication interface (I/F) circuit that connects the local medical server with two or more remote medical servers with respective medical repositories, wherein
the local medical server:
transmits a search request by a user to the plurality of remote medical servers, wherein the search request comprises a search key associated with a predetermined patient;
receives and displays medical information associated with the search request from the plurality of remote medical servers, wherein the medical information is organized into a user-selectable interface by the data integration controller;
transmits, to one or more of the remote medical servers associated with the medical information selected by the user, a medical data retrieval request to retrieve medical data associated with the medical information selected by the user from the user-selectable interface, wherein the medical data retrieval request is transmitted only to the one or more of the remote medical servers associated with the medical information selected by the user;
receives the medical data associated with the medical data retrieval request from the remote medical servers associated with the medical information selected by the user; and
displays the received medical data to the user.

18. The system according to claim 17, wherein the medical server is coupled to a local computer.

19. The system according to claim 17, wherein the local medical server displays, when the received medical data has been updated by any one of the remote medical servers associated with the medical information selected by the user, a message to the user that the received medical data has been changed, and wherein the message to the user includes an option for the user to retrieve and view the updated medical data.

20. The system according to claim 17, wherein each of the healthcare facilities within the network is associated with a Picture Archiving and Communication Systems (PACS), a cloud-based PACS, or a shared cloud server.
